(19) United States
(12) Patent Application Publication
(10) Pub. No.: US 2024/0178366 A1
(43) Pub. Date: May 30, 2024

(54) Cathode for Lithium Secondary Battery and Lithium Secondary Battery Including the Same

(71) Applicant: SK On Co., Ltd., Seoul (KR)

(72) Inventors: Jae Ram Kim, Daejeon (KR); Yong Seok Lee, Daejeon (KR); Ki Joo Eom, Daejeon (KR); Hyun Joong Jang, Daejeon (KR)

(21) Appl. No.: 18/516,607

(22) Filed: Nov. 21, 2023

(30) Foreign Application Priority Data
Nov. 28, 2022 (KR) 10-2022-0161573

(51) Int. Cl. H01M 4/1315; H01M 4/133; H01M 10/052

(52) U.S. Cl. CPC H01M 4/1315; H01M 4/133; H01M 10/052; H01M 2004/027

(57) ABSTRACT

A cathode for a lithium secondary battery includes a cathode current collector, a first cathode active material layer on the cathode current collector and a second cathode active material layer on the first cathode active material layer. The first cathode active material layer includes first cathode active material particles and a first binder. The first cathode active material particles include large-scaled particles having an average diameter (D50) from 10 μm to 20 μm and small-scaled particles having an average (D50) diameter from 1 μm to 9 μm. The second cathode active material layer includes second cathode active material particles having an average diameter (D50) from 1 μm to 20 μm and a second binder.

### CROSS-REFERENCE TO RELATED APPLICATION

This application claims priority to Korean Patent Application No. 10-2022-0161573 filed Nov. 28, 2022, the disclosure of which is hereby incorporated by reference in its entirety.

### BACKGROUND OF THE INVENTION

### 1. Field of the Invention

The present disclosure relates to a cathode for a lithium secondary battery and a lithium secondary battery including the same. More particularly, the present disclosure relates to a cathode for a lithium secondary battery including a lithium-nickel metal oxide-based cathode active material and a lithium secondary battery including the same.

### 2. Description of Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source of an electric automobile, a hybrid vehicle, etc.

Examples of the secondary battery includes, e.g., a lithium secondary battery, a nickel-cadmium battery, a nickel-hydrogen battery, etc. The lithium secondary battery is actively developed and applied due to high operational voltage and energy density per unit weight, a high charging rate, a compact dimension, etc.

For example, the lithium secondary battery may include an electrode assembly including a cathode, an anode and a separation layer (separator) interposed therebetween, and an electrolyte immersing the electrode assembly. The lithium secondary battery may further include an exterior material, e.g., in the form of a pouch, for accommodating the electrode assembly and the electrolyte.

For example, a lithium nickel-cobalt-manganese oxide used as a cathode active material may have a low pressed density. If a nickel content is increased to improve capacity properties, structural and electrochemical stability may be reduced. Thus, a cathode active material that may provide both high pressed density and structural stability may be advantageous.

### SUMMARY OF THE INVENTION

According to an aspect of the present disclosure, there is provided a cathode for a lithium secondary battery having improved resistance property and operational reliability.

According to an aspect of the present invention, there is provided a lithium secondary battery having improved resistance property and operational reliability.

A cathode for a lithium secondary battery includes a cathode current collector, a first cathode active material layer on the cathode current collector and a second cathode active material layer on the first cathode active material layer. The first cathode active material layer includes first cathode active material particles and a first binder. The first cathode active material particles include large-scaled particles having an average diameter (D50) from 10 μm to 20 μm and small-scaled particles having an average diameter (D50) from 1 μm to 9 μm. The second cathode active material layer include second cathode active material particles having an average diameter (D50) from 1 μm to 20 μm and a second binder. A content of the large-scaled particles based on a total weight of the first cathode active material particles is in a range from 50 wt % to 80 wt %, and a content of the small-scaled particles based on a total weight of the first cathode active material particles is in a range from 20 wt % to 50 wt %. A content of the second binder based on a total weight of the second cathode active material layer is less than or equal to a content of the first binder based on a total weight of the first cathode active material layer, and the content of the second binder is less than 1 wt %.

In some embodiments, the content of the second binder may be in a range from 0.3 wt % to 0.5 wt % based on the total weight of the second cathode active material layer.

In some embodiments, the content of the first binder may be in a range from 1 wt % or more based on the total weight of the first cathode active material layer.

In some embodiments, the content of the first binder may be 1.0 wt % to 1.2 wt % based on the total weight of the first cathode active material layer.

In some embodiments, the first cathode active material particles may have a distribution of a bi-modal form in which the large-scaled particles and the small-scaled particles are mixed.

In some embodiments, the second cathode active material particles may include a distribution of a unimodal form.

In some embodiments, each thickness of the first cathode active material layer and the second cathode active material layer may be in a range from 50 μm to 200 μm.

In some embodiments, a thickness ratio of the second cathode active material layer relative to the first cathode active material layer may be in a range from 1/9 to 9.

In some embodiments, each of the first cathode active material particles and the second cathode active material particles may include a lithium-nickel composite metal oxide, and a molar ratio of nickel among metal elements excluding lithium included in the lithium-nickel metal oxide may be 0.8 or more.

In some embodiments, the first cathode active material layer and the second cathode active material layer may each further include a conductive material.

In some embodiments, the conductive material may include carbon nanotube.

A lithium secondary battery includes a cathode for a lithium secondary battery according to embodiments as described above, and an anode facing the cathode.

A cathode for a lithium secondary battery according to embodiments of the present disclosure may include a cathode active material layer having a multi-layered structure that may include a first cathode active material and a second cathode active material. The first cathode active material layer may include first cathode active material particles of a bi-modal form including large-diameter particles and small-diameter particles. The second cathode active material layer may include second cathode active material particles of a unimodal form having an average diameter in a specific range.

The first cathode active material layer and the second cathode active material layer may include a first binder and a second binder, respectively, and a content of the second binder may be less than or equal to a content of the first binder, and may be less than 1 wt % based on a total weight of the second cathode active material layer.

According to the above-described construction of the cathode, a binder migration between the cathode active material layers may be suppressed to provide a uniform bonder distribution. Thus, reduction of adhesion between the cathode active material layer and a cathode current collector and resistance increase may be prevented while enhancing power and rapid-charge life-span properties.

### BRIEF DESCRIPTION OF THE DRAWINGS

FIG. 1 is a schematic cross-sectional view of a cathode for a lithium secondary lithium battery in accordance with example embodiments.

FIGS. 2 and 3 are a schematic plan view and a schematic cross-sectional view, respectively, of a lithium secondary battery in accordance with example embodiments.

FIG. 4 is a graph showing a binder distribution of a lithium secondary battery according to Example 1.

FIGS. 5 and 6 are graphs showing binder distributions of lithium secondary batteries according to Comparative Examples.

FIG. 7 is a graph showing a rapid-charge life-span properties of lithium secondary batteries according to Example 1 and Comparative Examples.

### DESCRIPTION OF THE INVENTION

According to embodiments of the present invention, a cathode for a lithium secondary battery including different types of cathode active material particles and including a multi-layered cathode active material layer is provided. Further, a lithium secondary battery including the cathode is also provided.

Hereinafter, embodiments of the present disclosure will be described in detail with reference to exemplary embodiments and examples, and the accompanying drawings. However, those skilled in the art will appreciate that such embodiments and drawings are provided to further understand the spirit of the present invention and do not limit subject matters to be protected as disclosed in the detailed description and appended claims.

The terms “first”, “second”, etc., used herein are not intended to an absolute position or an order, but are used relatively to distinguish different regions, levels or elements.

A cathode active material particle described herein may include a first cathode active material particle and a second cathode active material particle that may have a secondary particle structure in which a plurality of primary particles are integrally aggregated.

The term “a particle size” used herein may refer to an average diameter of the particles when the particles have spherical shapes, and may refer to an average major axis length when the particles are non-spherical. The average diameter of the particles may be a median diameter (D50) of the particles which is defined as a particle diameter corresponding to a diameter at 50% from a cumulative diameter distribution.

For example, the average particle diameter (D50) may be measured using a laser diffraction method. Specifically, the average particle diameter (D50) may be determined by dispersing target particles sample in a dispersion medium, introducing the sample into a commercially available laser diffraction particle size measurement device (e.g., Microtrac MT 3000), and irradiating an ultrasonic wave at about 28 kHz with a power of 60 W to obtain the average particle diameter (D50) at 50% of a volume-basis cumulative particle volume distribution.

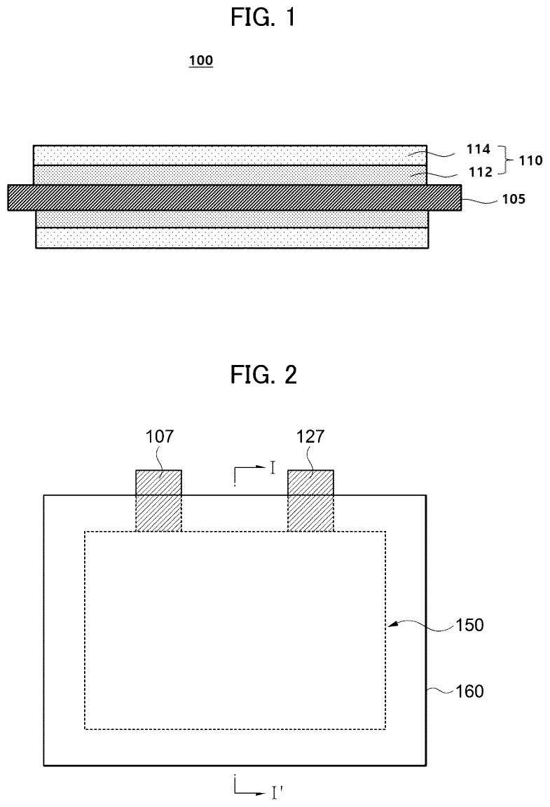

FIG. 1 is a schematic cross-sectional view of a cathode for a lithium secondary lithium battery in accordance with example embodiments.

Referring to FIG. 1, a cathode 100 includes a cathode active material layer 110 formed on at least one surface of a cathode current collector 105. The cathode active material layer 110 may be formed on both surfaces (e.g., upper and lower surfaces) of the cathode current collector 105.

The cathode current collector 105 may include, e.g., stainless steel, nickel, aluminum, titanium, copper, or an alloy thereof, and may include, e.g., aluminum or an aluminum alloy.

In example embodiments, the cathode active material layer 110 includes a first cathode active material layer 112 and a second cathode active material layer 114. Accordingly, the cathode material layer 110 may have a multi-layered structure (e.g., a double-layered structure).

As illustrated in FIG. 1, the first cathode active material layer 112 may formed on the surface of the cathode current collector 105, e.g., the upper and lower surfaces of the cathode current collector 105. The second cathode active material layer 114 may be formed on the first cathode active material layer 112.

The first cathode active material layer 112 may directly contact the surface of the cathode current collector. The second cathode active material layer 114 may directly contact a top surface of the first cathode active material layer 112.

In example embodiments, the first cathode active material layer 112 may include first cathode active materials that may include large-scaled particles having an average diameter (D50) in a range from 10 μm to 20 μm and small-scaled particles having an average diameter (D50) in a range from 1 μm to 9 μm.

For example, the average diameter (D50) of the large-scaled particles may be in a range from 10 μm to 20 μm. In some embodiments, the average diameter (D50) of the large-scaled particles may be in a range from 10 μm to 17 μm, or from 10 μm to 15 μm.

For example, the average diameter (D50) of the small-scaled particles may be in a range from 1 μm to 9 μm. In some embodiments, the average diameter (D50) of the small-scaled particles may be in a range from 1 μm to 7 μm, or from 1 μm to 5 μm.

In example embodiments, the large-scaled particles may be included in an amount from 50 weight percent (wt %) to 80 wt % based on a total weight of the first cathode active material particle. In one embodiment, a content of the large-scaled particles may be in a range from 60 wt % to 80 wt % based on the total weight of the first cathode active material particle.

The small-scaled particles may be included in an amount from 20 wt % to 50 wt % based on the total weight of the first cathode active material particle. In one embodiment, a content of the small particles may be in a range from 20 wt % to 40 wt % based on the total weight of the first cathode active material particle.

In example embodiments, a mixing weight ratio of the small-scaled particles relative to the large-scaled particles may be in a range from 1/10 to 1. In some embodiments, the mixing weight ratio of the small-scaled particles relative to the large-scaled particles may be in a range from 1/10 to 7/10, or from 2/10 to 6/10.

Within the above-described ranges of the average diameter and the content ratio of the large-scaled particles and the small scaled particles in the first cathode active material particles, the small-scaled particles may easily fill voids between the large-scaled particles, and empty spaces between the cathode active material particles may be reduced. Thus, a pressed density may be increased and an energy density may be enhanced. Additionally, propagation of heat and cracks due to penetration or pressure may be more effectively suppressed or reduced.

In example embodiments, the second cathode active material layer 114 may include second cathode active material particles having an average diameter (D50) in a range from 1 μm to 20 μm. In some embodiments, the average diameter (D50) of the second cathode active material particles may be in a range from 5 μm to 15 μm, or from 7 μm to 10 μm. Within the above-described average diameter range of the second cathode active material particles, cracks of the active material particles by a high pressure may be suppressed to enhance the energy density and to prevent a resistance increase.

In example embodiments, a standard deviation of the average diameter of the first cathode active material particles including the large-scaled and small-scaled particles or the second cathode active material particles may be greater than 0, and less than or equal to 2. In some embodiments, the standard deviation of the diameter of the first cathode active material particles or the second cathode active material particles may be greater than 0, and 1.5 or less, or in a range from 0.1 to 1.5.

For example, the average diameter of the large-scaled particles among the first cathode active material particles may be in a range from 10 μm to 20 μm, the average diameter of the small-scaled particles may be in a range from 1 μm to 9 μm, and the standard deviation of each of the diameters of the large-scaled particles and the small-scaled particles may be greater than 0, and 2 or less. Therefore, each of the large-scaled particles and the small-scaled particles may have a uniform average diameter distribution.

In one embodiment, the first cathode active material layer 112 may include first cathode active material particles in a bi-modal form. The bi-modal form may refer to a form in which spaces between the large-scaled particles are filled with the small-scaled particles. For example, the bi-modal form may provide two separate peaks when measured with a diffraction particle size measuring device (Microtrac MT 3000) using a laser diffraction. One of the two peaks may represent the average diameter of the large-scaled particles, and the other may represent the average diameter of the small-scaled particles.

In one embodiment, the second cathode active material layer 114 may include second cathode active material particles in a unimodal form. For example, the unimodal form may provide a single peak when measured with a diffraction particle size measuring device (Microtrac MT 3000) using a laser diffraction.

In example embodiments, the first cathode active material layer 112 and the second cathode active material layer 114 may include a first binder and a second binder, respectively, and a content of the second binder may be less than or equal to a content of the first binder. The content of the second binder may be less than 1 wt % based on the total weight of the second cathode active material layer.

For example, the content of the second binder may be less than 1 wt %, in a range from 0.1 wt % to 0.9 wt %, from 0.2 wt % to 0.7 wt %, or from 0.3 wt % to 0.5 wt % based on the total weight of the second cathode active material layer.

For example, the content of the first binder may be 1 wt % or more, in a range from 1 wt % to 1.5 wt %, or from 1 wt % to 1.2 wt % based on the total weight of the first cathode active material layer.

As described above, in the cathode active material layer of the multi-layer structure includes, the cathode active material particles of the bi-modal form may be included in an upper layer, the cathode active material particles of the unimodal form may be included in a lower layer, and the contents of the binders included in the upper and lower layers may be adjusting within the above-described ranges. From the above construction of the cathode, the binder distribution may become uniform while suppressing a binder migration in the cathode active material layer. Thus, adhesion degradation and resistance increase between the cathode active material layer and the cathode current collector may be prevented, and power and rapid-charge life-span properties may also be improved.

In example embodiments, the first cathode active material particles and the second cathode active material particles may each include a lithium-nickel metal oxide. In this case, the first cathode active material particles and the second cathode active material particles may contain nickel in the largest amount (molar ratio) among metals other than lithium.

For example, the first cathode active material particles may have a nickel content of about 80 mol % or more among the metals excluding lithium, and the second cathode active material particles may have a nickel content of about 80 mol % or more among the metals excluding lithium.

In some embodiments, the first cathode active material particles and the second cathode active material particles may each be represented by Chemical Formula 1 below.

LiₓM1ₐM2_{b}M3_{C}O_{y} [Chemical Formula 1]

In Chemical Formula 1, M1, M2 and M3 may each include at least one element selected from the group consisting of Ni, Co, Mn, Na, Mg, Ca, Ti, V, Cr, Cu, Zn, Ge, Sr, Ag, Ba, Zr, Nb, Mo, Al, Ga and B, and 0<x≤1.2, 2≤y≤2.02, 0.8≤a≤0.99, 0.01≤b+c≤0.2, and 0<a+b+c≤1.

In some embodiments, M1, M2, and M3 in Chemical Formula 1 may be nickel (Ni), manganese (Mn), and cobalt (Co), respectively.

For example, nickel may serve as a metal associated with a power and/or a capacity of a lithium secondary battery. As described above, the polycrystalline or secondary particle-shaped lithium-transition metal oxide having a nickel molar ratio of 0.8 or more may be employed as the first cathode active material particle, and the first cathode active material layer 112 may be in contact with the cathode current collector 105. Thus, high power and capacity properties of the cathode 100 may be effectively obtained.

For example, manganese (Mn) may serve as a metal related to mechanical and electrical stability of the lithium secondary battery. For example, cobalt (Co) may serve as a metal associated with a conductivity or a resistance of the lithium secondary battery.

In one embodiment, a concentration ratio (or a molar ratio) of nickel:cobalt:manganese in the first cathode active material particle may be adjusted to about 8:1:1. Additionally, a concentration ratio (or a molar ratio) of nickel:cobalt:manganese in the second cathode active material particle may be adjusted to about 8:1:1. In this case, the capacity and the power may be increased from nickel at a molar ratio of about 0.8, while cobalt and manganese may be included in substantially equal amounts to improve conductivity and life-span properties.

A first cathode slurry may be prepared by mixing and stirring the above-described first cathode active material particles with a binder, a conductive material and/or a dispersive agent in a solvent. The first cathode slurry may be coated on the cathode current collector 105, and then dried and pressed to form the first cathode active material layer 112.

A second cathode slurry may be prepared by a process substantially the same as or similar to that as described above. The second cathode slurry may be coated on the first cathode active material layer 112, and then dried and pressed to form the second cathode active material layer 114.

For example, a binder and a conductive material substantially the same or similar to those used in the formation of the first cathode active material layer 112 may also be used in the second cathode active material layer 114. As described above, the first cathode active material particles included in the first cathode slurry may include active material particles in the bi-modal form, and the second cathode active material particles included in the second slurry may include active material particles in the unimodal form.

In some embodiments, the cathode active material particles may be included in an amount from 80 wt % to 99 wt %, or from 85 wt % to 98.5 wt % based on a total weight of the cathode active material layer. In one embodiment, the first cathode active material particles may be included in an amount from 80 wt % to 99 wt %, or from 85 wt % to 98.5 wt % based on the total weight of a first cathode active material layer 112, and the second cathode active material particles may be included in an amount from 80 wt % to 99 wt %, or from 85 wt % to 98.5 wt % based on the total weight of the first cathode active material layer 112.

In some embodiments, the binder may be included in an amount from 0.1 wt % to 15 wt %, or from 0.1 wt % to 10 wt % based on the total weight of the cathode active material layer. In one embodiment, the binder may be included in an amount from 0.1 wt % to 15 wt %, or from 0.1 wt % to 10 wt % based on the total weight of the first cathode active material layer 112, and may be included in an amount from 0.1 wt % to 15 wt %, or from 0.1 wt % to 10 wt % based on the total weight of the second cathode active material layer 114.

In some embodiments, the conductive material may be included in an amount from 0.1 wt % to 15 wt %, or from 0.1 wt % to 10 wt % based on the total weight of the cathode active material layer. In one embodiment, the conductive material may be included in an amount from 0.1 wt % to 15 wt %, or from 0.1 wt % to 10 wt % based on the total weight of the first cathode active material layer 112, and may be included in an amount from 0.1 wt % to 15 wt %, or from 0.1 wt % to 10 wt % based on the total weight of the second cathode active material layer 114.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer may be reduced, and an amount of the cathode active material may be relatively increased. Thus, capacity and/or power properties of the secondary battery may be further improved.

The conductive material may be added to facilitate electron mobility between active material particles. For example, the conductive material may include a carbon-based material such as graphite, carbon black, graphene, carbon nanotube, etc. The conductive material may include a metal-based material such as tin, tin oxide, titanium oxide, a perovskite material such as LaSrCoO₃ or LaSrMnO₃, etc.

In some exemplary embodiments, the first cathode active material particle and/or the second cathode active material particle may further include a coating layer on a surface thereof. For example, the coating layer may include Al, Ti, Ba, Zr, Si, B, Mg, P, W, as alloy thereof, or an oxide thereof. These may be used alone or in combination of two or more therefrom. The cathode active material particles may be protected by the coating layer, and penetration stability and life-span properties may be further improved.

In one embodiment, the element, the alloy or the oxide of the above-described coating layer may be inserted as a dopant into the cathode active material particle.

In some embodiments, the first cathode active material layer 112 and the second cathode active material layer 114 may each have a thickness from 50 μm to 200 μm, e.g., from 100 μm to 200 μm. Within the above range, the thickness after being pressed may be reduced, so that a density of the cathode may be increased, and the adhesion with the cathode current collector may also be increased. Additionally, the thickness of the cathode active material layer may be properly adjusted within a range that may not degrade the effects from the embodiments of the present disclosure.

In one embodiment, a thickness ratio of the second cathode active material layer 114 to the first cathode active material layer 112 may be in a range from 1/9 to 9, from ⅕ to 5, from ½ to 2, from ½ to 1, or substantially 1. Within the above range, cracks of the cathode active material particles may be prevented, and power degradation due to reduced adhesion and increased resistance caused by the binder migration may be prevented.

In example embodiments, a density of the cathode active material layer 110 may be 3.5 g/cc or more, and 4.5 g/cc or less. In some embodiments, the density of the cathode active material layer 110 may be 3.5 g/cc or more, and 4.0 g/cc or less.

The term “density of the cathode active material layer” used herein refers to a total weight of the cathode active material layer divided by a total volume of the cathode active material layer. For example, the density may be calculated by punching the cathode to a certain size and measuring a mass and a volume of the cathode excluding the current collector.

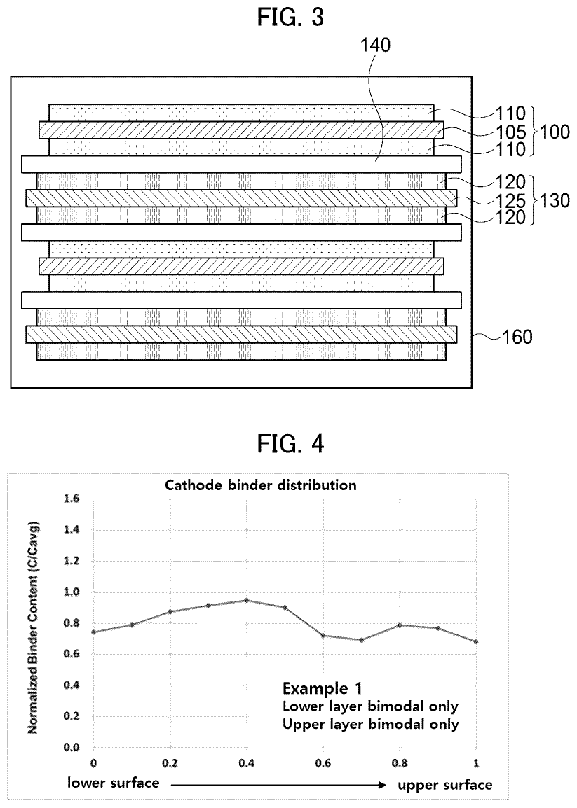

FIGS. 2 and 3 are a schematic plan view and a cross-sectional view, respectively, illustrating a lithium secondary battery in accordance with example embodiments. Specifically, FIG. 3 is a cross-sectional view taken along a line I-I′ in a thickness direction of the lithium secondary battery.

Referring to FIGS. 2 and 3, the lithium secondary battery 200 may include an electrode assembly 150 accommodated in a case 160. As illustrated in FIG. 3, the electrode assembly 150 may include an anode 100, a cathode 130 and a separator 140 that are repeatedly stacked.

The cathode 100 may include the cathode active material layer 110 coated on the cathode current collector 105. Although not illustrated in detail in FIG. 2, as described with reference to FIG. 1, the cathode active material layer 110 may include a stacked structure of the first cathode active material layer 112 and the second cathode active material layer 114.

The anode 130 may include an anode current collector 125 and an anode active material layer 120 formed by coating an anode active material on the anode current collector 125.

The anode active material may include a material capable of adsorbing and ejecting lithium ions. For example, a carbon-based material such as a crystalline carbon, an amorphous carbon, a carbon composite or a carbon fiber, a lithium alloy, a silicon-containing material or tin may be used as the anode active material.

The amorphous carbon may include, e.g., a hard carbon, coke, a mesocarbon microbead (MCMB) fired at a temperature of 1500° C. or less, a mesophase pitch-based carbon fiber (MPCF), etc. The crystalline carbon may include a graphite-based material such as artificial graphite, natural graphite, graphitized coke, graphitized MCMB, graphitized MPCF, etc. The lithium alloy may further include aluminum, zinc, bismuth, cadmium, antimony, silicon, lead, tin, gallium, indium, etc.

For example, the anode current collector 125 may include gold, stainless steel, nickel, aluminum, titanium, copper, or an alloy thereof. In an embodiment, the anode current collector 125 may include copper or a copper alloy

In some embodiments, a slurry may be prepared by mixing and stirring the anode active material with a binder, a conductive material and/or a dispersive agent in a solvent. The slurry may be coated on at least one surface of the anode current collector, and then dried and pressed to form the anode 130.

The binder and the conductive material substantially the same as or similar to those used for the cathode active material layer 110 may also be used. In some embodiments, the binder for forming the anode may include an aqueous binder such as styrene-butadiene rubber (SBR) for a compatibility with, e.g., the carbon-based active material, and carboxymethyl cellulose (CMC) may also be used as a thickener.

The separator 140 may be interposed between the cathode 100 and the anode 130. The separator 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separator 140 may also include a non-woven fabric formed from a glass fiber with a high melting point, a polyethylene terephthalate fiber, etc.

In some embodiments, an area (e.g., a contact area with the separator 140) and/or a volume of the anode 130 may be larger than that of the cathode 100. Accordingly, transfer of lithium ions generated from the cathode 100 to the anode 130 may be facilitated without, e.g., being precipitated. Thus, the effects of improving power and stability through the combination of the above-described first cathode active material layer 112 and second cathode active material layer 114 may be more easily implemented.

In example embodiments, an electrode cell may be defined by the cathode 100, the anode 130 and the separator 140, and a plurality of the electrode cells may be stacked to form an electrode assembly 150 that may have e.g., a jelly roll shape. For example, the electrode assembly 150 may be formed by winding, stacking or folding of the separator 140.

For example, the electrode assembly 150 may be accommodated together with an electrolyte in the case 160 to define the lithium secondary battery. In example embodiments, a non-aqueous electrolyte may be used as the electrolyte.

The non-aqueous electrolyte may include a lithium salt and an organic solvent. The lithium salt may be represented by Li⁺X“, and an anion of the lithium salt X” may include, e.g., F, Cl, Br, I, NO₃, N(CN)₂, BF₄, CIO₄, PF₆, (CF₃)₂PF₄, (CF₃)₃PF₃, (CF₃)₄PF₂, (CF₃)₅PF, (CF₃)₆P, CF₃SO₃, CF₃CF₂SO₃, (CF₃SO₂)₂N, (FSO₂)₂N, CF₃CF₂(CF₃)₂CO, (CF₃SO₂)₂CH, (SF₅)₃C,(CF₃SO₂)₃C,CF₃(CF₂)₇SO₃, CF₃CO₂, CH₃CO₂, SCN, (CF₃CF₂SO₂)₂N, etc.

For example, the organic solvent may include propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, dimethyl sulfoxide, acetonitrile, dimethoxyethane, diethoxyethane, vinylene carbonate, sulfolane, gamma-butyrolactone, propylene sulfite, tetrahydrofuran, etc. These may be used alone or in a combination of two or more therefrom.

As illustrated in FIG. 2, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

In FIG. 2, the cathode lead 107 and the anode lead 127 are illustrated as protruding from an upper side of the case 160 in the plan view, but the positions of the electrode leads are not limited as that in FIG. 2. For example, the electrode leads may protrude from at least one of both lateral sides of the case 160 or may protrude from a lower side of the case 160. Alternatively, the cathode lead 107 and the anode lead 127 may be formed to protrude from different sides of the case 160, respectively.

The lithium secondary battery may be manufactured in, e.g., a cylindrical shape using a can, a square shape, a pouch shape or a coin shape.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Example 1

### (1) Preparation of First Cathode Active Material Particle

First cathode active material particles containing large-scaled particles with an average diameter of 11 μm and small-scaled particles with an average diameter of 3 μm were manufactured from a lithium-nickel composite metal oxide having a composition of Li[Ni_{0.8}Co_{0.1}Mn_{0.1}]O₂). A mixing weight ratio of the small-scaled particles to the large-scaled particles was about ¼. In the measurement of the average diameters of the large-scaled and small-scaled particle using Microtrac MT 3000, two peaks were identified.

### (2) Preparation of Second Cathode Active Material Particle

Second cathode active material particles having an average diameter of 10 μm were prepared from a lithium-nickel composite metal oxide (Li[Ni_{0.8}CO_{0.1}Mn_{0.1}]O₂). In the measurement of the average diameter of the second cathode active material particles using Microtrac MT 3000, one peak was identified.

### (3) Fabrication of Secondary Battery

The above-prepared first cathode active material particles, CNT and PVDF were mixed in a mass ratio of 98.4:0.6:1, respectively, to prepare a first cathode slurry. The first cathode slurry was coated on an aluminum current collector, and then dried and pressed to form a first cathode active material layer.

The above-prepared second cathode active material particles, CNT, and PVDF were mixed in a mass ratio of 98.9:0.6:0.5, respectively, to form a second cathode slurry. The second cathode slurry was coated on a surface of the first cathode active material layer, and then dried and pressed to form a second cathode active material layer.

Accordingly, a cathode including the first cathode active material layer and the second cathode active material layer sequentially stacked on the cathode current collector was obtained.

Electrode densities of the first and second cathode active material layers were each 3.7 g/cc.

An anode slurry containing 93 wt % of artificial graphite as an anode active material, 5 wt % of KS6 as a flake type conductive material, 1 wt % of styrene-butadiene rubber (SBR) as a binder and 1 wt % of carboxymethyl cellulose (CMC) as a thickener was prepared. The anode slurry was coated, dried and pressed on a copper substrate to prepare an anode.

The cathode and the anode manufactured as described above were notched to a predetermined size, and an electrode cell was formed by interposing a separator (polyethylene, thickness: 25 μm) between the anode and the cathode. Each tab portion of the cathode and the anode was welded. The welded cathode/separator/anode assembly was placed in a pouch and three sides except for an electrolyte injection side were sealed. The electrode tab portions were also included in the sealing portion. An electrolyte was injected through the electrolyte injection side, and the electrolyte injection side was also sealed and impregnation for more than 12 hours was performed.

In the preparation of the electrolyte, a 1M LiPF₆ solution was prepared using a mixed solvent of EC/EMC/DEC(25/45/30; volume ratio), and then 1 wt % of vinylene carbonate (VC), 0.5 wt % of 1,3-propenesultone (PRS), and 0.5 wt % of lithium bis(oxalato)borate (LiBOB) was added.

### Example 2

A lithium secondary battery was manufactured by the same method as that in Example 1, except that the first cathode active material particles, CNT and PVDF were mixed in a mass ratio of 98.2:0.6:1.2, respectively, in the formation of the first cathode active material layer, and the second cathode active material particles, CNT and PVDF were mixed in a mass ratio of 99.1:0.6:0.3, respectively, in the formation of the second cathode active material layer.

### Example 3

A lithium secondary battery was manufactured by the same method as that in Example 1, except that the first cathode active material particles, CNT and PVDF were mixed in a mass ratio of 98.5:0.6:0.9, respectively, in the formation of the first cathode active material layer, and the second cathode active material particles, CNT and PVDF were mixed in a mass ratio of 98.5:0.6:0.9, respectively, in the formation of the second cathode active material layer.

### Comparative Example 1

A cathode active material slurry was prepared by mixing the second cathode active material particles prepared in Example 1, CNT and PVDF in a mass ratio of 98.4:0.6:1, respectively. The cathode slurry was coated on an aluminum current collector, and then dried and pressed to form a single cathode active material layer containing a cathode active material of the unimodal form.

### Comparative Example 2

A cathode active material slurry was prepared by mixing the first cathode active material particles prepared in Example 1, CNT and PVDF in a mass ratio of 98.4:0.6:1.0, respectively. The cathode slurry was coated on an aluminum current collector, and then dried and pressed to form a single cathode active material layer containing a cathode active material of the bi-modal form.

### Comparative Example 3

A lithium secondary battery was manufactured by the same method as that in Example 1, except that the first cathode active material particles, CNT and PVDF were mixed in a mass ratio of 98.4:0.6:1.0, respectively, in the formation of the first cathode active material layer, and the second cathode active material particles, CNT and PVDF were mixed in a mass ratio of 98.4:0.6:1.0, respectively, in the formation of the second cathode active material layer.

### Experimental Example

### 1. Adhesive Force

For each of the cathodes of Examples and Comparative Examples, an adhesive force was measured using an adhesion measuring device (IMADA Z Link 3.1). Specifically, the adhesive force was evaluated by measuring a force when a cathode surface was attached to a tape, and then peeled off at an angle of 90° angle.

### 2. Measurement of Binder Distribution.

After staining each cathode prepared in Examples and Comparative Examples, a cross-section of the electrode was analyzed by an SEM-EDAX. The results are shown in FIGS. 4 to 6. In FIGS. 4 to 6, a horizontal axis relatively shows a scanned position from a lower surface (0) of the cathode active material layer in contact with the current collector to an upper surface (1) of the cathode active material layer, and a vertical axis shows a relative binder concentration based on an average concentration of the binder (PVDF) in the multi-layered active material layer.

### 3. Resistance Property (DCIR)

Each secondary battery of Examples and Comparative Examples was charged and discharged for 10 seconds at a corresponding C-rate while increasing C-rate 0.2C, 0.5C, 1.0C, 1.5C, 2.0C, 2.5C and 3.0C at an SOC 50% point. The terminal voltage points were constructed in a straight line equation, and a slope was adopted as a DCIR.

### 4. Evaluation on Rapid Charge Life-Span Property

A rapid charge life-span property of each secondary battery of Examples and Comparative Examples was evaluated in a constant temperature (25° C.) chamber under conditions of step charging at a C-rate of 1.25C/1.0C/0.75C/0.5C and discharging at a ⅓C C-rate within a DOD72 (SOC8-80) range. After repeating 100/200/300 cycles with a 10-minute rest time between charging and discharging cycles, a rapid charge capacity retention was measured.

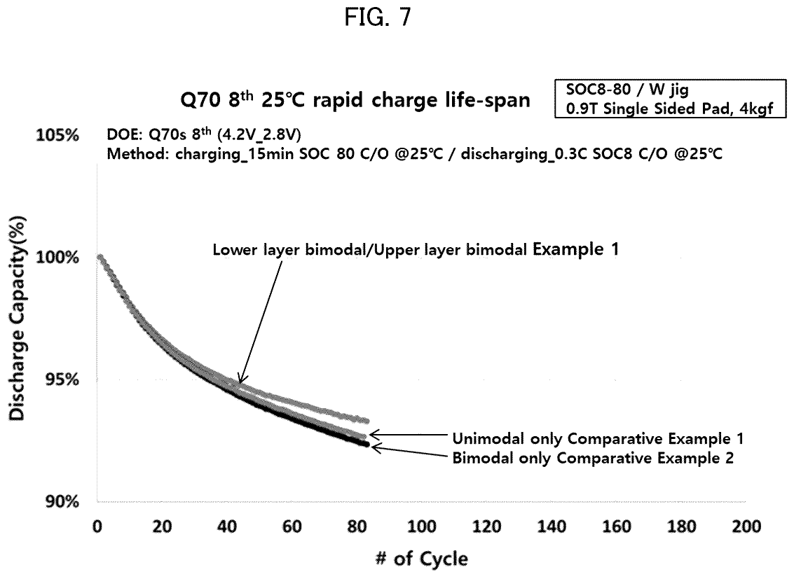

The results are shown in Table 1 and a graph of FIG. 7.

TABLE 1

| | | | | resis- | rapid charge |
|---|---|---|---|---|---|
| | binder content (wt %) | | adhesive | tance | life-span |
| | lower | upper | force | property | property |
| | layer | layer | (N) | (mΩ) | (%) |
| Example 1 | 1 | 0.5 | 0.31 | 0.882 | 92.7 |
| Example 2 | 1.2 | 0.3 | 0.34 | 0.871 | 92.4 |
| Example 3 | 0.9 | 0.9 | 0.34 | 0.880 | 93.5 |
| Comparative | 1.0 | — | 0.31 | 0.906 | 89.1 |
| Example 1 | | | | | |
| Comparative | — | 1.0 | 0.32 | 0.894 | 88.4 |
| Example 2 | | | | | |
| Comparative | 1.0 | 1.0 | 0.34 | 0.899 | 90.1 |
| Example 3 | | | | | |

Referring to FIG. 4 and Table 1, in Examples where the lower active material layer included the first cathode active material particles containing the large-scaled particles and the small-scaled particles of different average diameters, and the upper active material layer included the second cathode active material particles, the binder content in each layer was adjusted so that the binder migration within the cathode active material layer was suppressed and the uniform binder distribution was obtained. Accordingly, the adhesion between the cathode active material layer and the cathode current collector was increased, and improved resistance and rapid charge life-span properties were provided.

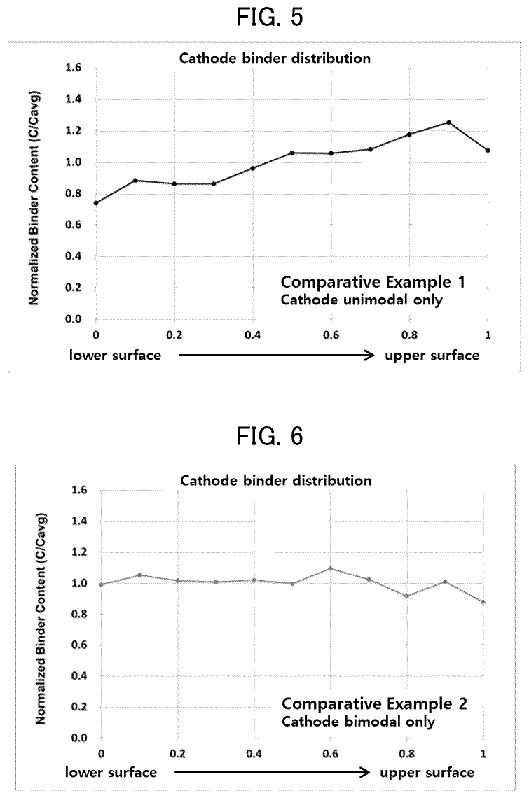

Referring to FIGS. 5 to 6 and Table 1, non-uniform binder distributions were provided in Comparative Examples 1 and 2. Additionally, the adhesion and resistance properties were also deteriorated.

Referring to Comparative Example 3, even though the lower active material layer of the multi-layered cathode included the first cathode active material particles and the upper active material layer included the second cathode active material particles, the binder content in the upper active material layer became 1 wt % or more to provide degraded resistance and rapid charge life-span properties compared to those from Examples.

What is claimed is:

1. A cathode for a lithium secondary battery, comprising:
a cathode current collector;
a first cathode active material layer on the cathode current collector, the first cathode active material layer comprising first cathode active material particles and a first binder, the first cathode active material particles comprising large-scaled particles having an average diameter (D50) from 10 μm to 20 μm and small-scaled particles having an average diameter from 1 μm to 9 μm; and
a second cathode active material layer on the first cathode active material layer, the second cathode active material layer comprising second cathode active material particles having an average diameter (D50) from 1 μm to 20 μm and a second binder,
wherein a content of the large-scaled particles based on a total weight of the first cathode active material particles is in a range from 50 wt % to 80 wt %, and a content of the small-scaled particles based on a total weight of the first cathode active material particles is in a range from 20 wt % to 50 wt, and
a content of the second binder based on a total weight of the second cathode active material layer is less than or equal to a content of the first binder based on a total weight of the first cathode active material layer, and the content of the second binder is less than 1 wt %.

2. The cathode for a lithium secondary battery according to claim 1, wherein the content of the second binder is in a range from 0.3 wt % to 0.5 wt % based on the total weight of the second cathode active material layer.

3. The cathode for a lithium secondary battery according to claim 1, wherein the content of the first binder is in 1 wt % or more based on the total weight of the first cathode active material layer.

4. The cathode for a lithium secondary battery according to claim 1, wherein the content of the first binder is in a range from 1.0 wt % to 1.2 wt % based on the total weight of the first cathode active material layer.

5. The cathode for a lithium secondary battery according to claim 1, wherein the first cathode active material particles have a distribution of a bi-modal form in which the large-scaled particles and the small-scaled particles are mixed.

6. The cathode for a lithium secondary battery according to claim 1, wherein the second cathode active material particles include a distribution of a unimodal form.

7. The cathode for a lithium secondary battery according to claim 1, wherein each thickness of the first cathode active material layer and the second cathode active material layer is in a range from 50 μm to 200 μm.

8. The cathode for a lithium secondary battery according to claim 7, wherein a thickness ratio of the second cathode active material layer relative to the first cathode active material layer is in a range from 1/9 to 9.

9. The cathode for a lithium secondary battery according to claim 1, wherein each of the first cathode active material particles and the second cathode active material particles includes a lithium-nickel composite metal oxide, and
a molar ratio of nickel among metal elements excluding lithium included in the lithium-nickel metal oxide is 0.8 or more.

10. The cathode for a lithium secondary battery according to claim 1, wherein the first cathode active material layer and the second cathode active material layer each further includes a conductive material.

11. The cathode for a lithium secondary battery according to claim 10, wherein the conductive material includes carbon nanotube.

12. A lithium secondary battery, comprising:
a cathode for a lithium secondary battery according to claim 1; and
an anode facing the cathode.
